(19) United States
(12) Patent Application Publication
(10) Pub. No.: US 2025/0086677 A1
(43) Pub. Date: Mar. 13, 2025

(54) ADVERTISEMENT PROVIDING DEVICE, ADVERTISEMENT PROVIDING METHOD, AND STORAGE MEDIUM STORING ADVERTISEMENT PROVIDING PROGRAM

(71) Applicant: DENSO CORPORATION, Kariya-city (JP)

(72) Inventors: Akihiro Ogasawara, Kariya-City (JP); Hiroaki Ando, Kariya-City (JP); Yuta Nishi, Kariya-City (JP); Yurika Ikeda, Kariya-City (JP)

(21) Appl. No.: 18/953,432

(22) Filed: Nov. 20, 2024

Related U.S. Application Data
(63) Continuation of application No. PCT/JP2023/017604, filed on May 10, 2023.

(30) Foreign Application Priority Data
May 26, 2022 (JP) 2022-086098

(51) Int. Cl. G06Q 30/0272; G06Q 30/0251

(52) U.S. Cl. CPC G06Q 30/0272; G06Q 30/0265

(57) ABSTRACT

An advertisement providing device includes: an acquisition unit acquiring a travel time between bus stops; a time setting unit setting, based on the travel time, an advertisement playable time during which at least one of advertisements is played back; a playback number calculation unit calculating a number of playbacks of the advertisements based on the advertisement playable time and an advertisement duration time that is set for each advertisement; and a playback unit playing back at least one of the advertisements according to the number of playbacks of the advertisements. When an interruption during travel operation has occurred, the playback number calculation unit recalculates the number of playbacks of the advertisements based on a remaining time of the advertisement playable time and a time of occurrence of the interruption.

### CROSS REFERENCE TO RELATED APPLICATION

This application is a continuation application of International Patent Application No. PCT/JP2023/017604 filed on May 10, 2023, which designated the U.S. and claims the benefit of priority from Japanese Patent Application No. 2022-086098 filed on May 26, 2022. The entire disclosure of all of the above application is incorporated herein by reference.

### TECHNICAL FIELD

The present disclosure relates to an advertisement providing device, an advertisement providing method, and a storage medium storing an advertisement providing program.

### BACKGROUND

For example, on public route buses, passengers are provided with information about the operation of the route bus and transfer information to other transportation, for improving passenger convenience. Further, on the route buses, position information of the route bus is acquired and audio-visual advertisements of stores in an area relevant to the route of the route bus is broadcast inside the vehicle, providing passengers with the information they need.

Conventionally, this type of vehicle has been provided with two separate systems, i.e., (a) an advertisement notification system that notifies audio-visual advertisements and (b) an operation information notification system that notifies the travel operation information of the buses, thereby making it necessary to prepare separate display devices for displaying the travel operation information and for displaying advertisement information, for example. Thus, such a system needs to be redundant, leading to a cost increase. Further, passengers who want to know the travel operation information will look at the display device displaying the travel operation information, without looking at the display device displaying the advertisement, thereby reducing the effects of the advertisement.

### SUMMARY

One aspect of the present disclosure is an advertisement providing device including: an acquisition unit acquiring a travel time between bus stops; a time setting unit setting, based on the travel time, an advertisement playable time during which at least one of advertisements is played back; a playback number calculation unit calculating a number of playbacks of the advertisements based on the advertisement playable time and an advertisement duration time that is set for each advertisement; and a playback unit playing back at least one of the advertisements according to the number of playbacks of the advertisements. When an interruption during travel operation has occurred, the playback number calculation unit recalculates the number of playbacks of the advertisements based on a remaining time of the advertisement playable time and a time of occurrence of the interruption.

### BRIEF DESCRIPTION OF THE DRAWINGS

Advantages of the present disclosure will become more apparent from the following detailed description made with reference to the accompanying drawings.

In the drawings:

FIG. 1 is a block diagram of an advertisement providing system according to a first embodiment;

FIG. 2 is a functional block diagram of an advertisement providing device;

FIG. 3 is a flowchart outlining processing operations;

FIG. 4 is an explanatory diagram of an advertisement playback method under normal circumstances;

FIG. 5 is a time chart showing a method of notifying advertisements and intervals between advertisements;

FIG. 6 is a schematic diagram of an operation panel surface that can be operated from a driver's seat;

FIG. 7 is an explanatory diagram of a method for playing back advertisements when an interruption occurs;

FIG. 8 is a second flowchart outlining the processing operations; and

FIG. 9 is a flowchart outlining the processing operations of a second embodiment.

### DETAILED DESCRIPTION

It is one objective of the present disclosure to provide an advertisement providing device, an advertisement providing method, and an advertisement providing program that are capable of effectively notifying advertisements to passengers while notifying them of travel operation information of a vehicle.

A first aspect of the present disclosure is an advertisement providing device including: an acquisition unit acquiring a travel time between bus stops; a time setting unit setting, based on the travel time, an advertisement playable time during which at least one of advertisements is played back; a playback number calculation unit calculating a number of playbacks of the advertisements based on the advertisement playable time and an advertisement duration time that is set for each advertisement; and a playback unit playing back at least one of the advertisements according to the number of playbacks of the advertisements. When an interruption during travel operation has occurred, the playback number calculation unit recalculates the number of playbacks of the advertisements based on a remaining time of the advertisement playable time and a time of occurrence of the interruption.

A second aspect of the present disclosure is an advertisement providing method includes: acquiring a travel time between bus stops; setting an advertisement playable time by subtracting a predetermined duration of time that is set for each bus stop from the travel time; calculating a number of playbacks of advertisements based on the advertisement playable time and an advertisement duration time that is set for each of the advertisements; playing back at least one of the advertisements according to the number of playbacks of the advertisements. When an interruption during travel operation has occurred, recalculating the number of playbacks of the advertisements based on a remaining time of the advertisement playable time and a time of occurrence of the interruption.

A third aspect of the present disclosure is a non-transitory, tangible storage medium storing an advertisement providing program causing, when executed by a computer of an advertisement providing device, the computer to: acquire a travel time between bus stops; set an advertisement playable time by subtracting a predetermined duration of time that is set for each bus stop from the travel time; calculate a number of playbacks of advertisements based on the advertisement playable time and an advertisement duration time that is set for each of the advertisements; play back at least one of the advertisements according to the number of playbacks of the advertisements; and when an interruption during travel operation has occurred, recalculate the number of playbacks of the advertisements based on a remaining time of the advertisement playable time and a time of occurrence of the interruption.

When an interruption during travel operation has occurred, the playback number calculation unit recalculates the number of playbacks of the advertisement based on (a) a remaining time of the advertisement playable time during which the advertisement can be played back and (b) a time when the interruption has occurred. Since the playback unit provides advertisements according to the calculated number of playbacks, advertisements can be played back according to the number of playbacks which has been changed in view of travel operation information of the vehicle, thereby enabling effective notification of the advertisement for the passengers.

Hereinafter, several embodiments of an advertisement providing device will be described with reference to the drawings. In the following description, the same reference numerals are given to substantially the same portions in each of the embodiments.

### First Embodiment

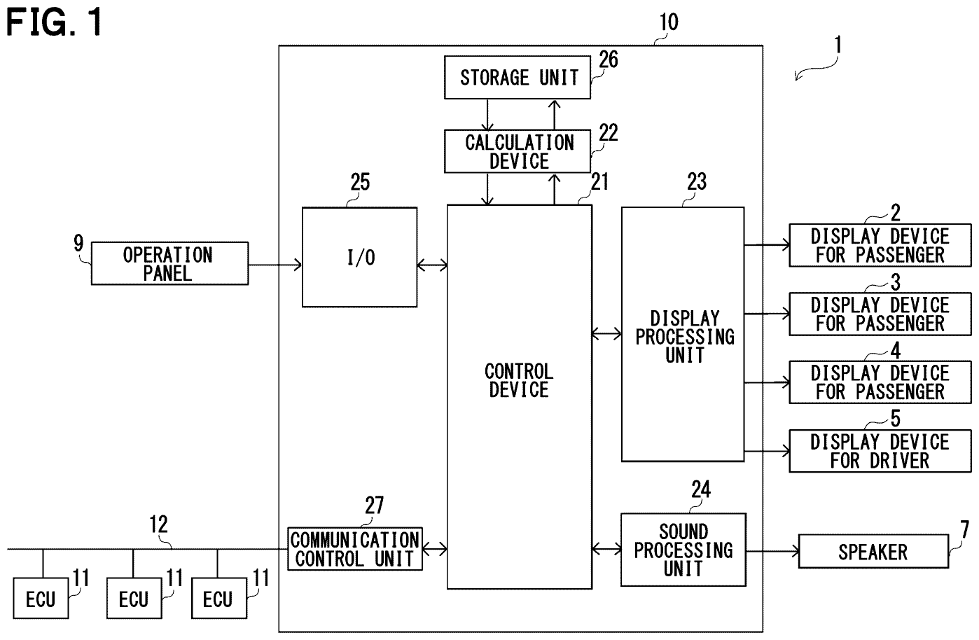

The following describes a first embodiment with reference to FIGS. 1 to 8. An advertisement providing system 1 for vehicle shown in FIG. 1 is mounted on a public route bus, and is configured by connecting a plurality of display devices 2, 3, and 4 for passengers that are installed at various positions inside the route bus. These display devices 2 to 4 of liquid crystal displays, organic EL displays, etc., are installed for passengers, and are configured to be capable of displaying contents in monochrome or full graphics based on a control of an electronic control device 10 connected to the display devices 2 to 4. The electronic control device 10 is called as an Electronics Control Unit (ECU).

As shown in FIG. 1, a large number of electronic control devices 10 and 11 are installed in the route bus, and are connected to each other via an in-vehicle network 12. The electronic control devices 10, 11 may be (a) provided as combination of separate ECUs, which may further be categorized as a display system ECU for notifying passengers and the driver of information, a surroundings monitoring system ECU for monitoring an area around the vehicle, and a travel control system ECU for controlling a travel of the vehicle, or (b) composed of an integrated ECU that combines some of these ECUs.

The travel control system ECU includes an electronic control unit that controls driving of the vehicle using a gasoline engine or diesel engine, or an electronic control unit that realizes an automatic driving mode according to various automatic driving levels. According to the above, travel control to be performed in either of a manual driving mode or an automatic driving mode. The electronic control devices 10 and 11 are connected to a DCM that is communicatively connected to an outside of the vehicle, enabling communication through a communication network outside the vehicle. The DCM is an abbreviation for data communication module.

Here, the electronic control device 10 for display control of travel operation information and advertisements related to the present application will be described by assigning a different reference numeral 10 from the other electronic control units 11. The electronic control device 10 is configured as an advertisement providing device of the present disclosure.

The electronic control device 10 is configured as a microcomputer having a processor, various storage units 26 such as a cache memory, a RAM, and a ROM, an I/O 25, and a bus connecting these components. The storage unit 26 represents a non-transitory, tangible storage medium that non-transitorily stores computer-readable programs and data. The non-transitory, tangible storage medium may be implemented by a semiconductor memory or the like. The electronic control device 10 is communicably connected to other electronic control units 11 provided in the vehicle via a communication control unit 27 and an in-vehicle network 12.

The electronic control device 10 is an ECU having functions as a control unit 21, a calculation unit 22, a display processing unit 23, a sound processing unit 24, the I/O 25, the storage unit 26, and the communication control unit 27. The control device 21 is constituted by using the above-mentioned processor as a main component, and realizes a predetermined control function by executing a program stored in the storage unit 26. Although the electronic control device 10 is shown as being configured by using one ECU, the same may also be configured by using a plurality of ECUs, each of which provides part of processing capacity of the one ECU in a sharing manner regarding the internal physical resources.

Based on a control of the control device 21, a calculation device 22 calculates a display area on display screens of the display devices 2, 3, 4 for a display of various information consisting of images, sentences, characters, symbols, etc. stored in the storage unit 26, calculates to display contents such as images in which one of the display areas on the display screen of the display devices 2, 3, 4, and outputs the display contents to the display processing unit 23 via the control device 21.

The display processing unit 23 performs display processing of the contents such as images in the above-mentioned display areas on the display screens of the display devices 2 to 5 under the control of the control device 21. In such manner, the display devices 2 to 5 display the contents such as images in an overlapping manner, on each of display layers.

The contents displayed on the display devices 2 to 4 for passengers include the travel operation information based on GTFS data, and advertisements notified while the bus is traveling between bus stops. GTFS is an abbreviation for General Transit Feed Specification, and GTFS data indicates data configured in accordance with a bus information format that is publicly available in Japan. The GTFS data includes static data and dynamic data.

The static data mainly indicates information about bus stops, routes, and services, as well as timetables, fares, and the like. Specifically, the static data includes business information of the bus company, bus stop signpost information indicating bus stops and signposts, route information indicating the bus route, service information indicating the bus services regarding the bus operation, and business office information of the business office that operates the service. Further, the static data shows passing time information that sets the passing time at stops for each service of the bus, operation division information that indicates the operation division such as weekdays or holidays, operation day information that indicates days of bus operation, fare attribute information that indicates fare information such as distance and transfer discounts, fare definition information, drawing information for specifying waypoints other than signposts, operation interval information that indicates operation intervals when buses operate at regular intervals without setting a timetable, transfer information that indicates bus transfer information, provision information that indicates information about the organization that publishes the data and the validity period of the published data, translation information that is set when converting Japanese notation to other languages, and the like.

The passing time information includes an arrival time, a departure time and the like. The dynamic data is used in conjunction with the static data, and indicates the latest route information, vehicle position information, and operation information, and indicates real-time information called as GTFS real-time. In the present embodiment, a form in which at least the static data is stored in the storage unit 26 is described. However, the dynamic data may be acquired as real-time information from outside the vehicle and successively updated and stored in the storage unit 26, for utilizing such information. The technical significance of the present embodiment is achievable only with a part or all of the static data, and the dynamic data is not necessarily required for achieving the above.

The display devices 2 to 4 are installed in positions that attract the attention of passengers on route buses, making it easy for passengers to check the travel operation information of the route bus. Therefore, generally speaking, advertisement displayed on the display devices 2 to 4 has higher effectiveness.

The display device 5 for a driver is provided near a center console where it is easily visible from the driver's seat, and displays the travel operation information of the route bus under control of the electronic control device 10. Further, a speaker 7 for the interior of the bus is installed on the route bus.

The sound processing unit 24 can output driver's voice from the speaker 7 under control of the control device 21, upon having an input of the driver's voice from the driver. Further, the sound processing unit 24 outputs guidance information designated by the driver from the speaker 7 under control of the control device 21. The display device 5 for the driver is configured to have an operation panel 9. The operation panel 9 is a touch panel configured on a surface of the display device 5, and when an operation input is made to the operation panel 9, the I/O 25 accepts the operation input and outputs an operation signal to the control device 21. The control device 21 executes control based on an operation signal from the operation panel 9.

An example of an operation panel surface is shown in FIG. 6. By operating the operation panel 9, the driver can select the travel operation information and the guidance information to be displayed on the display devices 2 to 4. Further, the driver can determine when to provide information to passengers. According to the above, the driver can notify the guidance information to the inside of the vehicle.

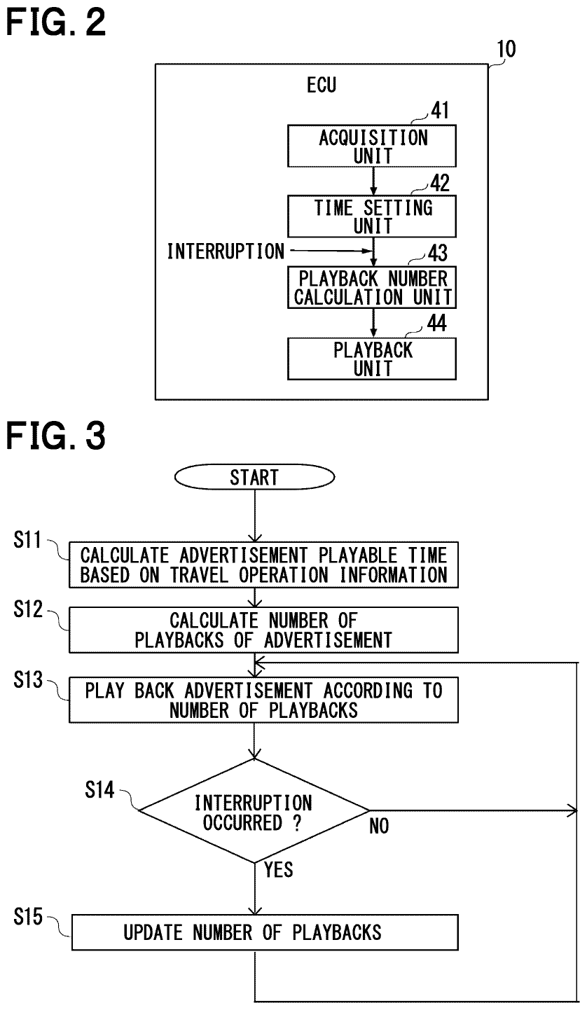

Next, functions of application programs stored in the storage unit 26 will be described. The electronic control device 10 executes the application programs stored in the storage unit 26 to realize functions of an acquisition unit 41, a time setting unit 42, a playback number calculation unit 43, and a playback unit 44, as shown in FIG. 2.

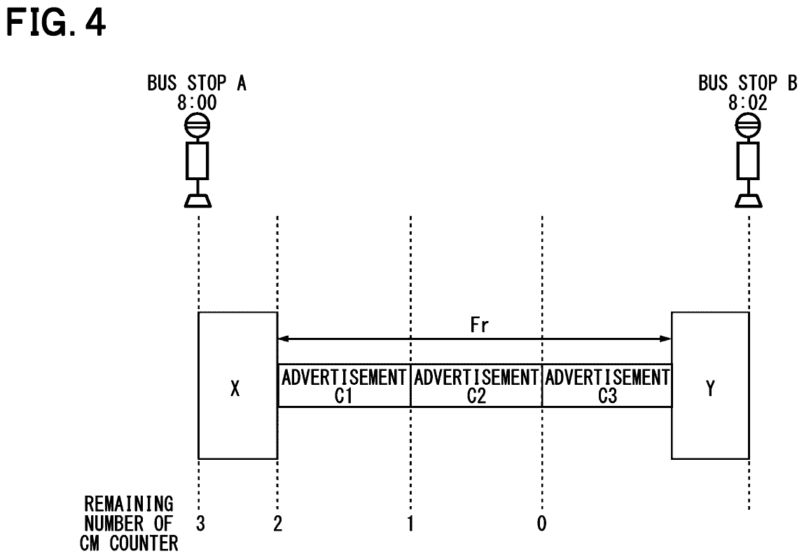

FIG. 3 shows a normal flow of an advertisement playback process based on the program. In S11, the control device 21 calculates an advertisement playable time Fr based on the travel operation information from the GTFS data. Here, the acquisition unit 41 acquires, from the GTFS data, information on time when the bus stops at a bus stop, and acquires a travel time between the bus stops on a route along which the bus travels. Then, the time setting unit 42 sets the advertisement playable time Fr by subtracting a predetermined duration of time set corresponding to a travel between the bus stops, e.g., time X+time Y in FIG. 4, from the travel time. The acquisition unit 41 can acquire the travel time between the bus stops in a unit of minutes. However, as a result of acquiring a travel time in a unit of minutes, a difference in time in a unit of minutes between adjacent bus stops may become zero. In such a case, the time setting unit 42 calculates the advertisement playable time Fr as zero.

The time X shown in FIG. 4 indicates a time required for guidance immediately after departure from a bus stop A, and the time X is a time required for a guidance “Thank you for boarding. The door is closing. Please watch your step. The next stop is ‘(Stop) B’.” which is set for providing travel operation information of predetermined type and warnings via the display devices 2 to 4. Further, the time Y indicates a time required for a guidance to arrive at the next stop, and such a time Y is provided to provide travel operation information of a predetermined type, a warning such as “Arriving at ‘(a bus stop) B’ shortly. Please be careful of sudden stops.” and the like, via the display devices 2 to 4. The information given during the times X and Y may also include “Please be quiet during the ride.” or the like, which is etiquette guidance.

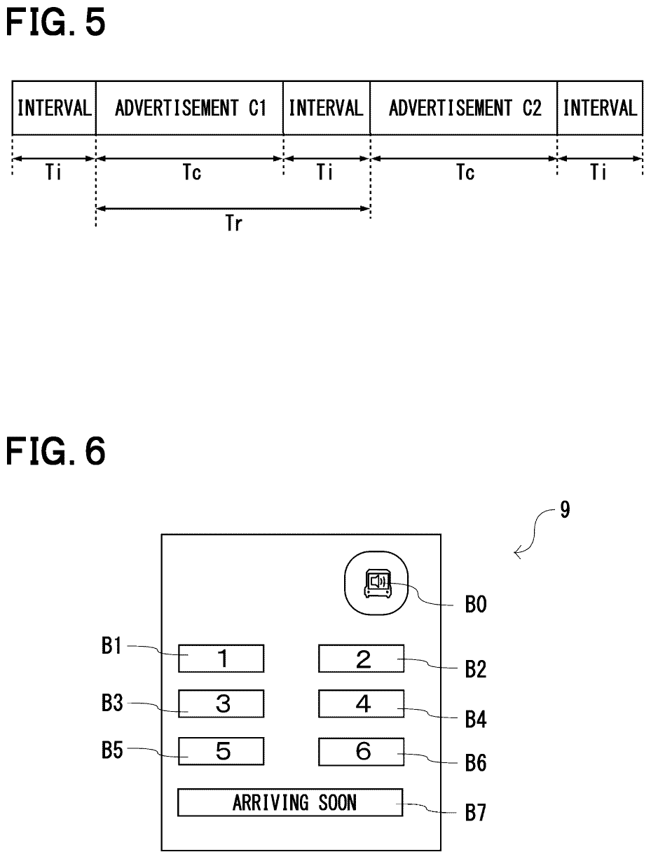

In S12, the playback number calculation unit 43 calculates a playback number n of the advertisement based on the advertisement playable time Fr and an advertisement duration time Tr set for each of the advertisements C1, C2, and C3. For example, as shown in FIG. 5, the advertisement duration time Tr is calculated by adding an interval Ti (e.g., 5 seconds) to time Tc[1], Tc[2], . . . (e.g., 15 seconds) of each of the advertisements C1, C2, etc. As shown in the example described above, in order to alleviate the discomfort felt by passengers, it is advisable to provide a predetermined interval Ti[n] between advertisement C1 and the next advertisement C2. If the number of advertisements to be played back within the advertisement playable time Fr is n, the time can be calculated by n×(Tc[1 . . . n]+Ti)+Ti. Therefore, the playback number n of the advertisement can be calculated by determining n that satisfies Fr>n×(Tc[1 . . . n]+Ti)+Ti.

Then, in S13, the playback unit 44 plays back the advertisements according to the playback number n of the advertisement. The control device 21 sets the playback number n in a CM counter, and decrements the CM counter every time an advertisement, e.g., the advertisement C1, . . . , is played back. When the final advertisement C3, which has the playback number n, is broadcast, the CM counter becomes zero. In such manner, the advertisements are played back efficiently between the bus stops A and B. Normally, while the bus is traveling through the bus stops A and B or traveling between the bus stops A and B, advertisements are played back as described above. However, for example, the driver may also warn passengers or may guide etiquette, i.e., how to behave on board. At such time, the driver generates an interruption during travel operation by operating one or more of operation buttons B0 to B7 on the operation panel 9 in FIG. 6, and guidance information stored in advance in the storage unit 26 is notified from the display devices 2 to 4 and from the speaker 7 inside the vehicle.

When the driver operates the operation button B0, a notification output from the speaker 7 to the inside of the vehicle is activated. Various types of guidance information are stored in the storage unit 26, and the various types of guidance information are linked to the operation buttons B1 to B7 shown in FIG. 6. Respectively different guidance information is linked to the operation buttons B1 to B7. Further, the operation button B7 is linked to guidance information indicating that the bus will soon arrive at the next stop B during an operation between the bus stops A and B. When the driver performs an operation input on one of the operation buttons B1 to B7, the control device 21 reads out from the storage unit 26 the guidance information linked to the relevant one of the operation buttons B1 to B7, and causes the display devices 2 to 4 and the speaker 7 to notify the guidance information.

When the control device 21 receives an operation input from the operation panel 9, it determines that an interruption has occurred in S14 of FIG. 3. When an interruption during travel operation occurs, the playback number calculation unit 43 recalculates the playback number n of the advertisement based on a remaining time of the advertisement playable time Fr and the time of the interruption in S15.

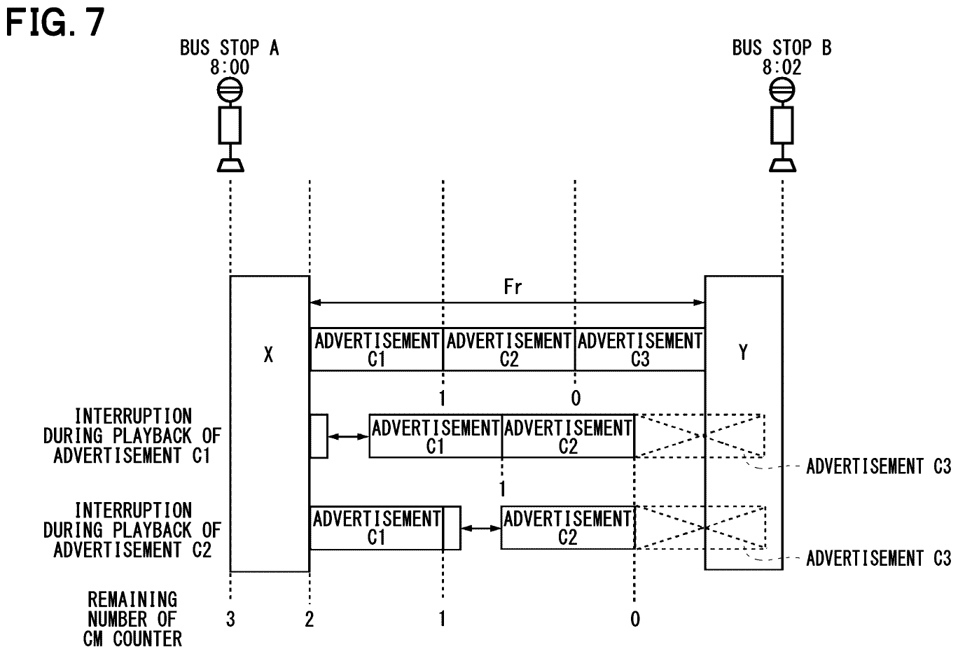

For example, as shown in FIG. 7, when an interruption occurs while the display devices 2 to 4 are playing back the advertisement C1, the control device 21 refers to an identification number of the guidance information operated by the driver. The control device 21 determines whether the advertisements C2 and C3 are playable after subtracting an interruption guidance time corresponding to the identification number. For example, when the control device 21 determines that there is no time to playback the advertisement C3, it deletes a playback plan of the advertisement C3.

Further, as shown in FIG. 7, when an interruption occurs while the display devices 2 to 4 are playing back the advertisement C2, the control device 21 refers to the identification number of the guidance information operated by the driver. Then, the control device 21 subtracts an interrupt guidance time corresponding to the identification number, and then determines whether the advertisement C3 is playable. For example, when the control device 21 determines that there is no time to playback the advertisement C3, it deletes a playback plan of the advertisement C3. In such manner, the advertisements C1 to C3 are appropriately playable between the bus stops A and B in a selective manner.

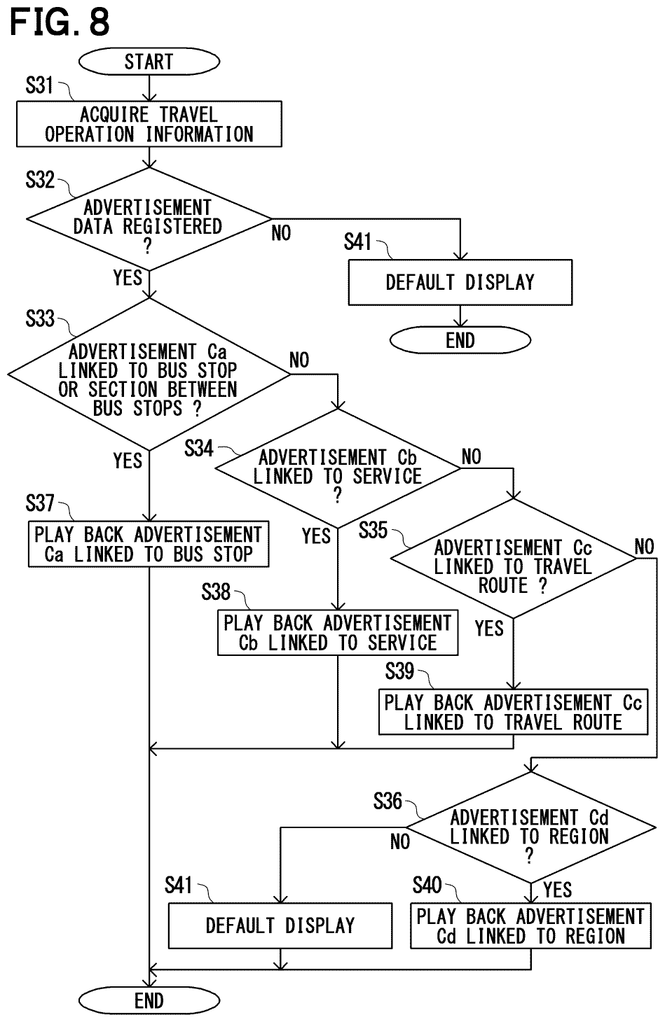

Next, priority order of playback of the advertisements will be described with reference to FIG. 8. FIG. 8 shows a method for playing back advertisements Ca to Cd based on priority order. The storage unit 26 stores advertisements Ca to Cd. These advertisements Ca to Cd respectively have, assigned thereto, an advertisement content linked either to the bus stops A and B, a section between the bus stops A and B, a route bus service, a travel route, or a region. Here, it is desirable that a priority order is set among the advertisements Ca to Cd, and, in particular, after the above-mentioned interruption occurs, when the playback number n of the advertisement is updated by the playback number calculation unit 43, it is desirable that the playback unit 44 plays back the advertisements in a descending order of priority.

At such time, it is desirable that the priority is set as follows in a descending order from highest to lowest: advertisement Ca linked to a bus stop or a section between bus stops; advertisement Cb linked to a service; advertisement Cc linked to a travel route; and advertisement Cd linked to a region. In S31 of FIG. 8, when the acquisition unit 41 acquires travel operation information based on GTFS data, the control device 21 determines whether or not data of the advertisement Ca linked to the bus stops A, B or the section between the bus stops A and B, the advertisement Cb linked to a service, the advertisement Cc linked to a travel route, or the advertisement Cd linked to a region is registered in the storage unit 26.

If none of the advertisements Ca to Cd is registered in the storage unit 26, the control device 21 determines NO in S32 or S36, and in S41 displays a default advertisement, such as an advertisement of a bus operator operating the route bus or the like, on the display devices 2 to 4. Conversely, if any of the advertisements Ca to Cd is registered in the storage unit 26, the control device 21 determines in S33, S34, S35, and S36 in a written order whether, in storage unit 26, the advertisement Ca linked to the bus stops A, B or the section between the bus stops A and B is stored, the advertisement Cb linked to the service is stored, the advertisement Cc linked to the travel route is stored, and the advertisement Cd linked to the region is stored, and plays back the advertisement Ca, Cb, Cc, and/or Cd in S37, S38, S39, and S40 in a descending order of priority. The priority order is set based on a travel position where the route bus is operating or the like.

For example, the advertisement Ca linked to the bus stops A and B or the section between the bus stops A and B may include an advertisement for stores located near the bus stops A and B close to the road on which the bus is currently traveling, such as doctors' offices, dentists' offices, supermarkets, convenience stores, and the like. Further, for example, the advertisement Cb linked to a service may be an advertisement for a facility that satisfies a condition of a scope ranging from the first to the last bus stop of the service route. It is desirable for the advertisement Cb, for example, to play back an advertisement for different consumer demand for different time ranges, respectively for commuting hours, daytime, and nighttime.

Further, for example, the advertisement Cc linked to a travel route may be an advertisement for a facility adjacent to a specific detour route, such as when a route bus makes a detour along a specific route while traveling from the starting point to the end point of the route. Further, for example, the advertisement Cd linked to a region is not limited to a section from the starting point to the end point of a particular route bus, but may include an advertisement for a facility within an entire range operated by the route bus operator. Further, the advertisement may also be for a facility within a specific region, i.e., within a prefecture, a city, a town, a village or the like.

By having the control device 21 that plays the advertisements Ca to Cd on the display devices 2 to 4 in such manner, the advertisements Ca to Cd can be appropriately played back for a specific bus stop or a specific section between bus stops, for a specific time period, for a specific region, with a prospect for increased advertising revenue. The advertisements Ca to Cd can be effectively appealing to passengers. Further, contents that passengers should pay priority attention to, such as warnings and etiquette guidance, may be given a higher priority than the advertisements Ca to Cd described above.

According to the present embodiment, when an interruption during travel operation occurs, the playback number calculation unit 43 is configured to recalculate the playback number n of the advertisement based on a remaining time of the advertisement playable time Fr and the time of the interruption. In such manner, it is possible to optimize a playback timing and the playback number n of the advertisement while utilizing the travel operation information of the route bus, and prevents interference of the playback timing between (a) the advertisements C1 to C3, Ca to Cd and (b) the travel operation information. Further, the advertisement playable time Fr between the bus stops A and B is calculated, and the playback number n is updated when an interruption occurs, thereby the playback number n of the advertisement is adjustable.

Further, according to the present embodiment, the travel operation information, the warnings, and the advertisements can be displayed on a single information transmission medium, e.g., on one or more of the display devices 2 to 4, thereby reducing an initial cost and a maintenance cost, for achieving cost reduction.

### Second Embodiment

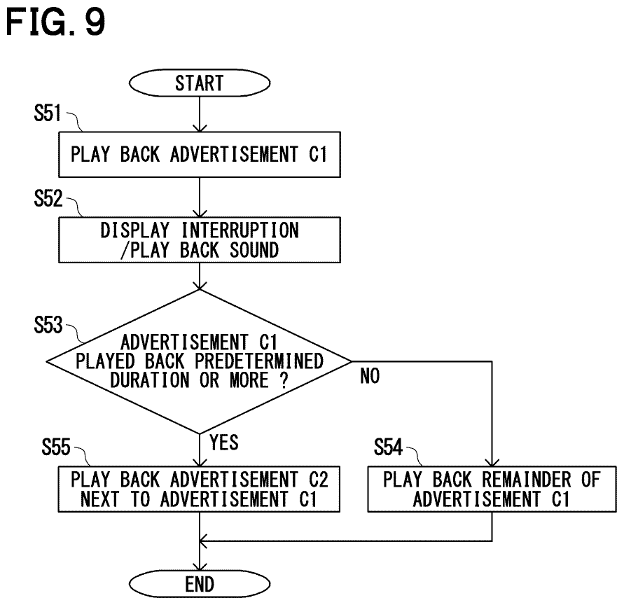

The second embodiment will be described with reference to FIG. 9. In the present embodiment, a method for playing back a subsequent advertisement when an interruption occurs during a playback of the advertisement C1 will be described as another embodiment. For example, as shown in FIG. 9, when an interruption during travel operation occurs while playing back the advertisement C1 in S51, the control device 21 executes interruption processing during travel operation instead of advertisement notification in playback in S52, thereby displaying the travel operation information on the display devices 2 to 4 and playing back an audio of the travel operation information from the speaker 7.

At such time, after an end of the interruption processing, the playback unit 44 may once again play back the advertisement C1 in an interrupted playback forcibly. However, in the present embodiment, the playback unit 44 determines in S53 whether the advertisement C1 has already been played back for a predetermined duration of time (for example, a predetermined number of seconds) or more, and, if the advertisement C1 has not yet been played back for the predetermined duration of time or more, the playback unit 44 plays back a remainder of the advertisement C1 in S54.

In other words, even when an interruption during the travel operation occurs while playing back the advertisement C1, in case that playback of the advertisement C1 is interrupted before predetermined duration of time, after an end of the interruption processing, the playback unit 44 may resume the interrupted playback of the advertisement C1 from an interrupted point in time.

Conversely, if it is determined in S53 that the advertisement has already been played back for the predetermined duration of time or more, the control device 21 plays back the advertisement C2 having the next highest priority in S55. In other words, if (a) an interruption during travel operation occurs while playing back the advertisement C1, and (b) the advertisement C1 in playback has already been played back for a predetermined duration of time or more, after an end of the interruption processing, the playback unit 44 may play back a new advertisement C2 instead of playing back the advertisement C1 in interrupted playback. According to the present embodiment, the advertisements C1 and C2 can be appropriately played back, and the effectiveness of the advertisement is improvable.

### Other Embodiments

The present disclosure is not limited to the embodiments described above, but can be implemented by various modifications, and can be applied to various embodiments without departing from the spirit of the present disclosure. In the above embodiment, the time setting unit 42 sets the advertisement playable time Fr by subtracting a predetermined duration of time (time X+time Y) set corresponding to the travel between the bus stops from the travel time, but these times X and Y do not need to be taken into consideration. In particular, since time Y is a time set when the travel time between the bus stops is fixed, such as when a route bus is operated by automatic driving, time Y does not need to be taken into consideration during manual driving.

The control device 21 may acquire position information by acquiring real-time information, which is dynamic data of GTFS data from the outside, and based on such position information, may display advertisements for nearby facilities corresponding to the acquired position information on the display devices 2 to 4, and the like. For example, if a well-known navigation system is installed on board, i.e., in a route bus, position information may be acquired from the navigation system, and advertisements for nearby facilities close to the acquired position may be displayed based on the acquired position information.

The methods of the control device 21 described in the present disclosure may be implemented by a special-purpose computer provided by configuring a processor and memory programmed to perform one or more functions embodied in a computer program. Alternatively, the control device 21, the display processing unit 23 and the methods thereof described in the present disclosure may be implemented by a special-purpose computer provided by configuring a processor with one or more dedicated hardware logic circuits. Alternatively, the control device 21 and the methods thereof described in the present disclosure may be implemented by one or more special purpose computers configured as a combination of (a) a processor and memory programmed to perform one or more functions and (b) a processor configured by one or more hardware logic circuits. The computer program may be stored, as instructions to be executed by a computer, in a computer-readable, non-transitory, tangible storage medium.

In the drawing, reference numerals 2, 3, and 4 indicate display devices, 41 indicates an acquisition unit, 42 indicates a time setting unit, 43 indicates a playback number calculation unit, and 44 indicates a playback unit.

The present disclosure has been described in accordance with the embodiments described above. However, it is to be understood that the present disclosure is not limited to such embodiments and configurations described above. The present disclosure includes various modification examples and equivalents thereof. Further, various combinations and modes, as well as other combinations and modes having one element, more than one element, or less than one element added thereto, are within the scope and idea of the present disclosure.

What is claimed is:

1. An advertisement providing device, comprising:
an acquisition unit acquiring a travel time between bus stops;
a time setting unit setting, based on the travel time, an advertisement playable time during which at least one of advertisements is played back;
a playback number calculation unit calculating a number of playbacks of the advertisements based on the advertisement playable time and an advertisement duration time that is set for each advertisement; and
a playback unit playing back at least one of the advertisements according to the number of playbacks of the advertisements, wherein
when an interruption during travel operation has occurred, the playback number calculation unit recalculates the number of playbacks of the advertisements based on a remaining time of the advertisement playable time and a time of occurrence of the interruption.

2. The advertisement providing device according to claim 1, wherein
a priority is set to each of the advertisements, and
when the number of playbacks of the advertisements is calculated by the playback number calculation unit, the playback unit plays back the advertisements in a descending order of the priority.

3. The advertisement providing device according to claim 2, wherein
each of the advertisements is linked to at least one of a bus stop or a section between bus stops, a service, a travel route, or a region, and
the advertisement linked to the bus stop or the section between bus stops, the advertisement linked to the service, the advertisement linked to the travel route, and the advertisement linked to the region have priorities in a descending order.

4. The advertisement providing device according to claim 1, wherein
when an interruption during the travel operation occurs while playing back the advertisements, interruption processing during the travel operation is executed instead of playing back the advertisements, and
the playback unit is further configured to play back again the advertisement which was interrupted by the interruption after completion of the interruption processing.

5. The advertisement providing device according to claim 4, wherein
if a predetermined duration of time or less of playing back of the advertisement has elapsed when the advertisement is interrupted, the playback unit resumes, after completion of the interruption processing, playback of the interrupted advertisement from an interrupted point in time.

6. The advertisement providing device according to claim 4, wherein
if a predetermined duration of time or more of playing back of the advertisement has elapsed when playback of the advertisement is interrupted, the playback unit plays back, after completion of the interruption processing, another advertisement instead of playing back the interrupted advertisement.

7. An advertisement providing method, comprising:
acquiring a travel time between bus stops;
setting an advertisement playable time by subtracting a predetermined duration of time that is set for each bus stop from the travel time;
calculating a number of playbacks of advertisements based on the advertisement playable time and an advertisement duration time that is set for each of the advertisements;
playing back at least one of the advertisements according to the number of playbacks of the advertisements, wherein
when an interruption during travel operation has occurred, recalculating the number of playbacks of the advertisements based on a remaining time of the advertisement playable time and a time of occurrence of the interruption.

8. A non-transitory, tangible storage medium storing an advertisement providing program causing, when executed by a computer of an advertisement providing device, the computer to:
acquire a travel time between bus stops;
set an advertisement playable time by subtracting a predetermined duration of time that is set for each bus stop from the travel time;
calculate a number of playbacks of advertisements based on the advertisement playable time and an advertisement duration time that is set for each of the advertisements;
play back at least one of the advertisements according to the number of playbacks of the advertisements; and
when an interruption during travel operation has occurred, recalculate the number of playbacks of the advertisements based on a remaining time of the advertisement playable time and a time of occurrence of the interruption.
